(19) United States
(12) Patent Application Publication
(10) Pub. No.: US 2024/0356194 A1
(43) Pub. Date: Oct. 24, 2024

(54) QUICK-RELEASE MODULE FOR ANTENNA CONNECTORS

(71) Applicant: GIGA-BYTE TECHNOLOGY CO.,LTD., New Taipei City (TW)

(72) Inventors: Chih-Ming Lai, New Taipei City (TW); Yung-Shun Kao, New Taipei City (TW); Fang-Cih Chen, New Taipei City (TW)

(73) Assignee: GIGA-BYTE TECHNOLOGY CO.,LTD., New Taipei City (TW)

(21) Appl. No.: 18/582,535

(22) Filed: Feb. 20, 2024

(30) Foreign Application Priority Data
Apr. 20, 2023 (TW) 112114692

(51) Int. Cl. H01Q 1/08; H01R 13/627

(52) U.S. Cl. CPC H01Q 1/088; H01R 13/627

(57) ABSTRACT

A quick-release module for antenna connectors includes first and second double connector assemblies. The first double connector assembly includes a bottom plate and two first connectors extending from the bottom plate. The bottom plate is integrated with the first connectors. Each first connector includes an inclined outer wall inclined away from the bottom plate and a first engaging portion located between the inclined outer wall and the bottom plate. The second double connector assembly is detachably plugged into the first double connector assembly and includes a housing base and two second connectors fixed on the housing base. Each second connector includes a first elastic arm and a second engaging portion located at an end of the first elastic arm. When the second double connector assembly is plugged into the first double connector assembly, the second engaging portion moves along the inclined outer wall and engages with the first engaging portion.

### CROSS-REFERENCE TO RELATED APPLICATION

This application claims the priority benefit of Taiwan application serial no. 112114692, filed on Apr. 20, 2023. The entirety of the above-mentioned patent application is hereby incorporated by reference herein and made a part of this specification.

### BACKGROUND

### Technical Field

This disclosure relates to a quick-release module, and particularly to a quick-release module for antenna connectors.

### Description of Related Art

Currently, the bonding between the male SMA antenna connector and the female SMA antenna connector requires a wrench to screw the two connectors to each other, which is inconvenient to disassemble and assemble. In addition, when the two antenna connectors are bonded for a long time, due to the influence of gravity, the antenna connectors may tilt toward the direction of gravity and become loose from the bracket installed.

### SUMMARY

This disclosure provides a quick-release module for antenna connectors, which has the effect of quick assembly. Through the design of two sets of double connectors, besides being able to disassemble and assemble the double connectors at once to increase efficiency, the structural strength can also be increased and the probability of the double connectors being tilted due to gravity can be reduced.

A quick-release module for antenna connectors of this disclosure includes a first double connector assembly and a second double connector assembly. The first double connector assembly includes a bottom plate and two first connectors extending from the bottom plate. The bottom plate is integrated with the two first connectors. Each of the first connectors includes an inclined outer wall inclined away from the bottom plate and a first engaging portion located between the inclined outer wall and the bottom plate. The second double connector assembly is detachably plugged into the first double connector assembly and includes a housing base and two second connectors fixed on the housing base. Each of the second connectors includes a first elastic arm and a second engaging portion located at an end of the first elastic arm. When the second double connector assembly is plugged into the first double connector assembly, the second engaging portion moves along the corresponding inclined outer wall and engages with the first engaging portion.

In an embodiment of this disclosure, the bottom plate includes a first surface and a second surface opposite to each other. The two first connectors protrude from the first surface. The first double connector assembly also includes two sleeves protruding from the second surface, two sets of inclined blocks located outside of the two sleeves and inclined away from the bottom plate, and two third engaging portions located between the two sets of inclined blocks and the bottom plate. Each set of inclined blocks surrounds the corresponding sleeve and forms a gap with the sleeve.

In an embodiment of this disclosure, the quick-release module for antenna connectors further includes a bracket including two holes. The first double connector assembly is detachably assembled on the bracket. When the first double connector assembly is assembled on the bracket, the two sleeves pass through the two holes respectively. Each set of inclined blocks is pushed by a wall surface of the corresponding hole and is deformed toward a direction of the corresponding sleeve until the set of inclined blocks passes through the hole, so that the wall surface of the hole engages with the third engaging portion.

In an embodiment of this disclosure, the bracket includes an outer surface and an inner surface opposite to each other. When the first double connector assembly is assembled on the bracket, the bottom plate and the two first connectors protrude from the outer surface, and the two sleeves and the two sets of inclined blocks protrude from the inner surface.

In an embodiment of this disclosure, the first double connector assembly also includes an exterior wall extending from the bottom plate and located outside the two first connectors, a third engaging portion located on the exterior wall and away from the bottom plate, and an inclined surface protruding from the exterior wall and inclined toward a direction of the bottom plate.

In an embodiment of this disclosure, the quick-release module for antenna connectors further includes a bracket including a hole. The first double connector assembly is detachably assembled on the bracket. When the first double connector assembly is assembled on the bracket, the bottom plate and a part of the exterior wall pass through the hole, and the inclined surface is pushed by a wall surface of the hole, so that the exterior wall is deformed toward a direction of the first connector until the wall surface engages with the third engaging portion.

In an embodiment of this disclosure, the bracket includes an outer surface and an inner surface opposite to each other. When the first double connector assembly is assembled on the bracket, the bottom plate and a part of the exterior wall protrude from the inner surface, and the inclined outer wall protrudes from the outer surface.

In an embodiment of this disclosure, a height of the exterior wall protruding from the bottom plate is greater than a distance between the first engaging portion and the bottom plate. When the second double connector assembly is plugged into the first double connector assembly, the second engaging portion is located inside the exterior wall.

In an embodiment of this disclosure, a thickness of the first elastic arm gradually decreases along with a height protruding from the housing base to present an inclined inner wall.

In an embodiment of this disclosure, the second engaging portion includes an arc surface. The inclined outer wall has a sharp corner near the first engaging portion. When the second double connector assembly is unplugged from the first double connector assembly, the arc surface of the second engaging portion deforms the first elastic arm along the sharp corner and disengages from the first engaging portion.

Based on the above, in the quick-release module for antenna connectors of this disclosure, when the second double connector assembly is plugged into the first double connector assembly, the second engaging portion moves along the corresponding inclined outer wall and engages with the first engaging portion. Therefore, the quick-release module for antenna connectors of this disclosure directly engages during the insertion process to implement quick assembly without the need for tools. In addition, the second double connector assembly of the quick-release module for antenna connectors of this disclosure is detachably plugged into the first double connector assembly. Such design can not only disassemble and assemble the two double connectors at once to increase the disassembling and assembling efficiency, but can also enable the first double connector assembly to have a more robust structural strength since the bottom plate of the first double connector assembly is integrated with the two first connectors, reducing the probability of the first double connector assembly being tilted due to gravity when the second double connector assembly is plugged into the first double connector assembly.

### BRIEF DESCRIPTION OF THE DRAWINGS

FIG. 1 and FIG. 2 are schematic diagrams of an assembly process of a quick-release module for antenna connectors according to an embodiment of this disclosure.

FIG. 3 is a schematic cross-sectional view of FIG. 2.

FIG. 4 is a schematic diagram of a first double connector assembly and a bracket of the quick-release module for antenna connectors in FIG. 1.

FIG. 5 is a schematic exploded view of FIG. 4.

FIG. 6 and FIG. 7 are schematic diagrams of an assembly process of a quick-release module for antenna connectors according to another embodiment of this disclosure.

FIG. 8 is a schematic cross-sectional view of FIG. 7.

FIG. 9 and FIG. 10 are schematic exploded views from different perspectives of a first double connector assembly and a bracket of the quick-release module for antenna connectors in FIG. 6.

### DETAILED DESCRIPTION OF DISCLOSED EMBODIMENTS

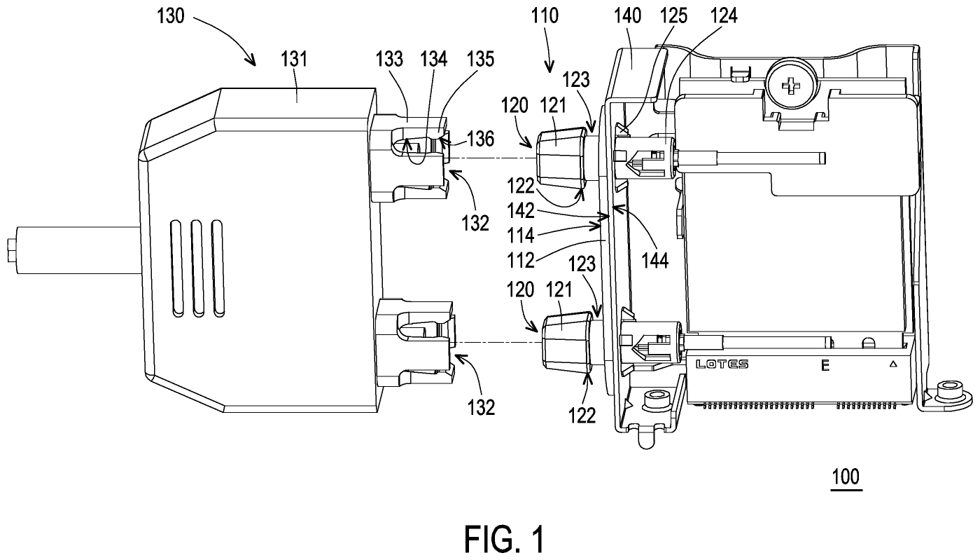

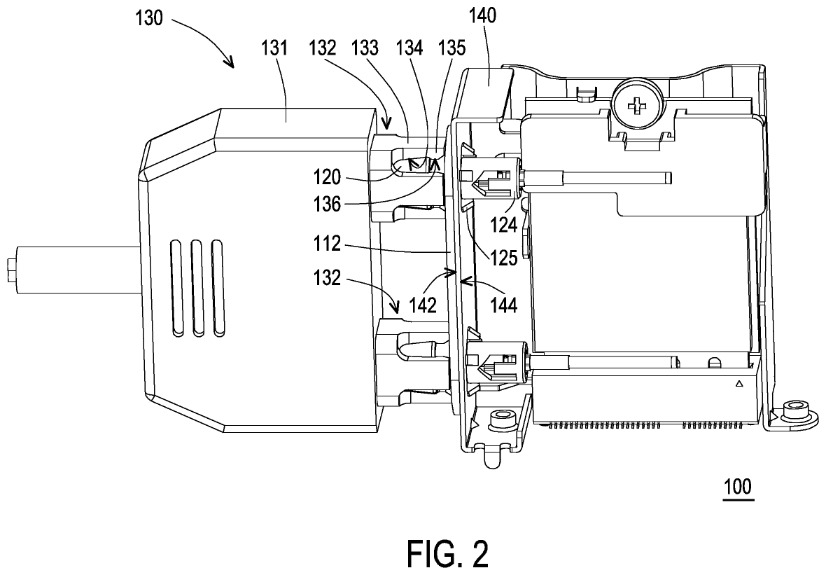

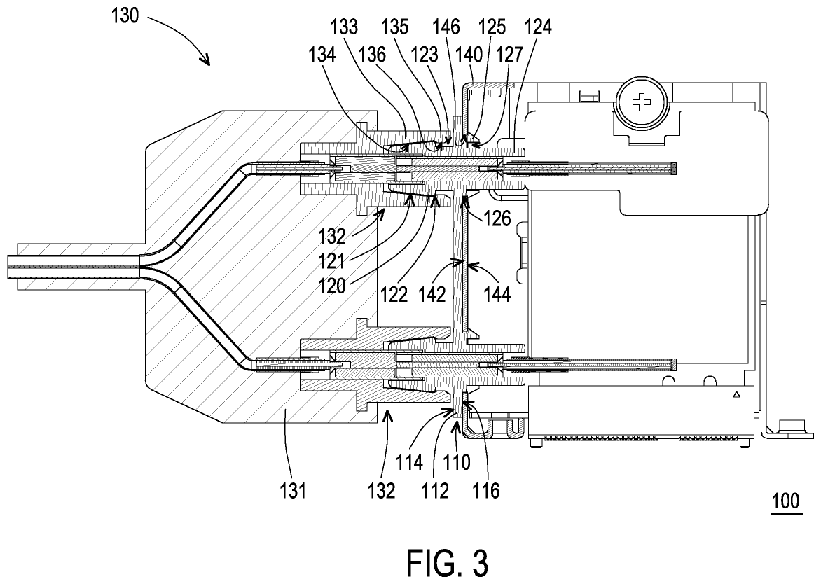

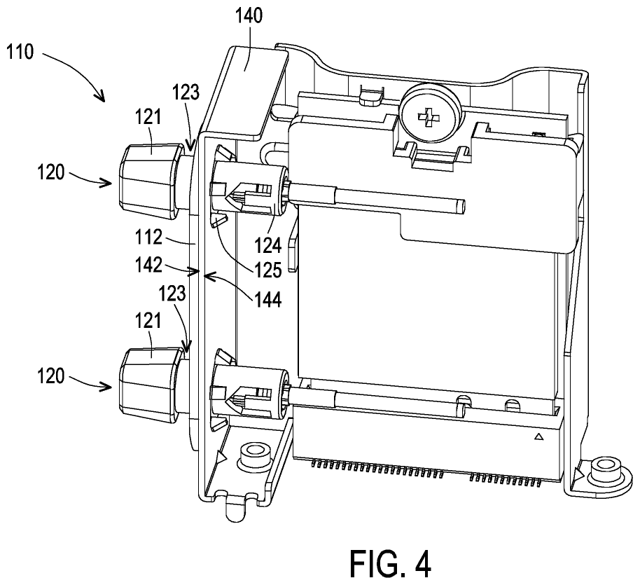

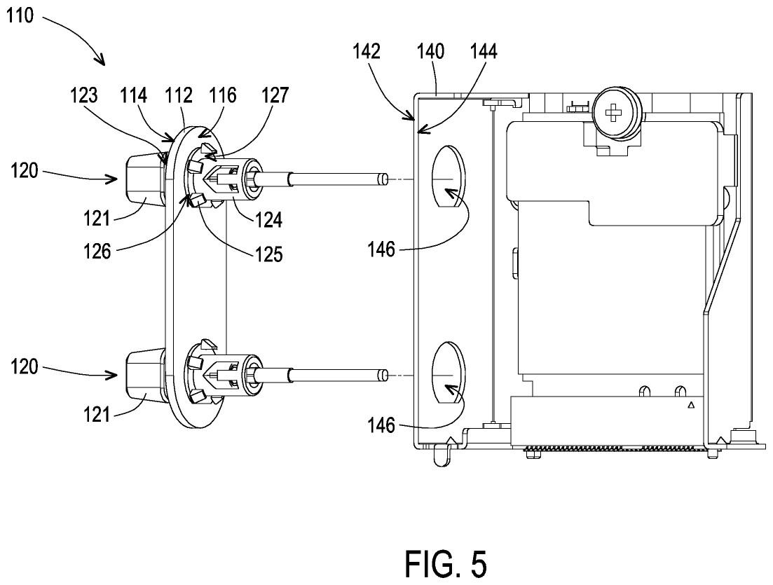

FIG. 1 and FIG. 2 are schematic diagrams of an assembly process of a quick-release module for antenna connectors according to an embodiment of this disclosure. FIG. 3 is a schematic cross-sectional view of FIG. 2. FIG. 4 is a schematic diagram of a first double connector assembly and a bracket of the quick-release module for antenna connectors in FIG. 1. FIG. 5 is a schematic exploded view of FIG. 4.

Please refer to FIG. 1 to FIG. 5. The quick-release module for antenna connectors 100 of this embodiment includes a first double connector assembly 110 and a second double connector assembly 130. FIG. 4 and FIG. 5 show that the first double connector assembly 110 includes a bottom plate 112 and two first connectors 120 extending from the bottom plate 112. The bottom plate 112 is integrated with the two first connectors 120. The bottom plate 112 includes a first surface 114 and a second surface 116 opposite to each other. The two first connectors 120 protrude from the first surface 114.

As seen in FIG. 1, each of the first connectors 120 includes an inclined outer wall 121 inclined away from the bottom plate 112 and a first engaging portion 123 located between the inclined outer wall 121 and the bottom plate 112. The first engaging portion 123 is, for example, a groove, but is not limited thereto.

The second double connector assembly 130 is detachably plugged into the first double connector assembly 110 and includes a housing base 131 and two second connectors 132 fixed on the housing base 131. Each of the second connectors 132 includes at least a first elastic arm 133 and at least a second engaging portion 135. Each second engaging portion 135 is located at an end of the corresponding first elastic arm 133. In this embodiment, each of the second connectors 132 has, for example, four first elastic arms 133 and four second engaging portions 135, but the number of the first elastic arms 133 and the second engaging portions 135 is not limited thereto.

As shown in FIG. 1 to FIG. 3, when the second double connector assembly 130 is plugged into the first double connector assembly 110, each second engaging portion 135 moves along the inclined outer wall 121 of the corresponding first connector 120 and is slightly expanded and deformed, and the second engaging portion 135 extends into the first engaging portion 123 (the groove). The originally slightly deformed second engaging portion 135 restores and engages with the first engaging portion 123. Therefore, the quick-release module for antenna connectors 100 of this disclosure directly engages during the insertion process to implement quick assembly without the need for tools.

As shown in FIG. 3, in this embodiment, a thickness of the first elastic arm 133 gradually decreases along with a height protruding from the housing base 131 to present an inclined inner wall 134. Such design enables the first elastic arm 133 to be more easily deformed at the second engaging portion 135, and when the second engaging portion 135 engages with the first engaging portion 123, the first elastic arm 133 does not interfere with the inclined outer wall 121 of the second connector 132. In this embodiment, the slope of the inclined inner wall 134 corresponds to the slope of the inclined outer wall 121. Of course, the form of the first elastic arm 133 is not limited thereto.

In addition, in this embodiment, each second engaging portion 135 includes an arc surface 136, and the inclined outer wall 121 has a sharp corner 122 near the first engaging portion 123. When the second double connector assembly 130 is unplugged from the first double connector assembly 110, the arc surface 136 of the second engaging portion 135 moves along the sharp corner 122, so that the first elastic arm 133 is expanded and deformed to leave the first engaging portion 123. Therefore, the quick-release module for antenna connectors 100 of this disclosure may be directly removed during the separation process to implement quick disassembly without the need for tools.

In addition, as shown in FIG. 5, the quick-release module for antenna connectors 100 further includes a bracket 140. The bracket 140 includes an outer surface 142 and an inner surface 144 opposite to each other and two holes 146 penetrating the outer surface 142 and the inner surface 144.

The first double connector assembly 110 is detachably assembled on the bracket 140. The first double connector assembly 110 also includes two sleeves 124 protruding from the second surface 116 of the bottom plate 112, two sets of inclined blocks 125 located outside the two sleeves 124 and inclined away from the bottom plate 112, and two third engaging portions 126 located between the two sets of inclined blocks 125 and the bottom plate 112. The third engaging portion 126 is, for example, a groove, but is not limited thereto.

Each set of inclined blocks 125 surrounds the corresponding sleeve 124 and forms a gap 127 with the sleeve 124. The gap 127 is used for the set of inclined blocks 125 to be deformed toward the direction of the sleeve 124.

As shown in FIG. 5 and FIG. 4, when the first double connector assembly 110 is assembled on the bracket 140, the two sleeves 124 pass through the two holes 146 respectively. Each set of inclined blocks 125 is pushed by a wall surface of the corresponding hole 146 and is deformed toward the direction of the corresponding sleeve 124 until the set of inclined blocks 125 passes through the hole 146, so that the wall surface engages with the third engaging portion 126.

Therefore, when the first double connector assembly 110 is assembled on the bracket 140, the bottom plate 112 and the two first connectors 120 protrude from the outer surface 142 of the bracket 140, and the two sleeves 124 and the two sets of inclined blocks 125 protrude from the inner surface 144 of the bracket 140, so that the first double connector assembly 110 is fixed on the bracket 140.

To detach the first double connector assembly 110 from the bracket 140, the two sets of inclined blocks 125 are pressed toward the direction of the two sleeves 124, so that the two sets of inclined blocks 125 are retracted and deformed to pass through the holes 146.

In other words, in the quick-release module for antenna connectors 100 of this embodiment, the first double connector assembly 110 may be quickly disassembled and assembled on the bracket 140 without the need for tools, which is quite convenient.

It is worth mentioning that in this embodiment, the docking design of the first double connector assembly 110 and the second double connector assembly 130 can not only disassemble and assemble the two double connectors at once to increase the disassembling and assembling efficiency, but can also enable the first double connector assembly 110 to have a more robust structural strength since the bottom plate 112 of the first double connector assembly 110 is integrated with the two first connectors 120, which can effectively reduce the probability of the first double connector assembly 110 being tilted relative to the bracket 140 due to gravity when the second double connector assembly 130 is plugged into the first double connector assembly 110. Therefore, the first double connector assembly 110 can be more firmly fixed on the bracket 140.

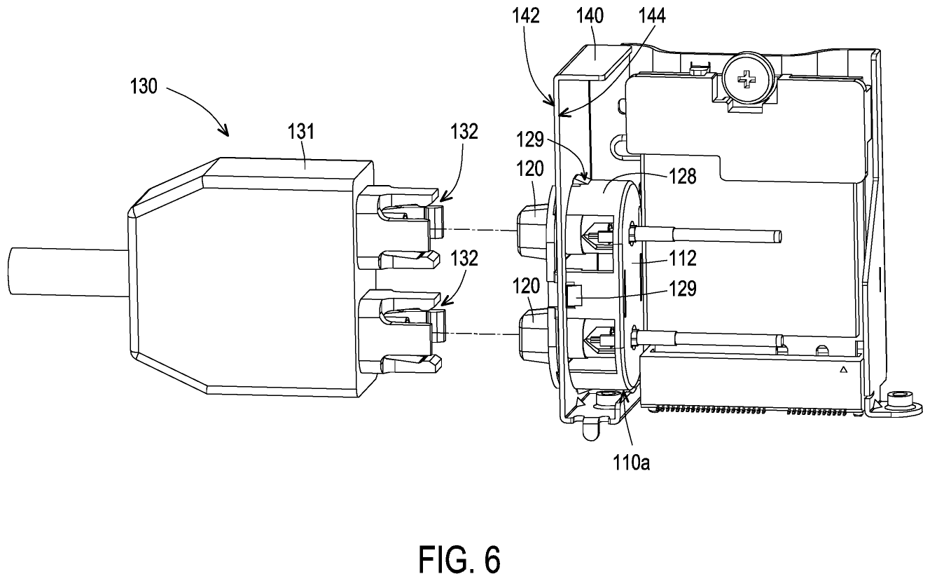

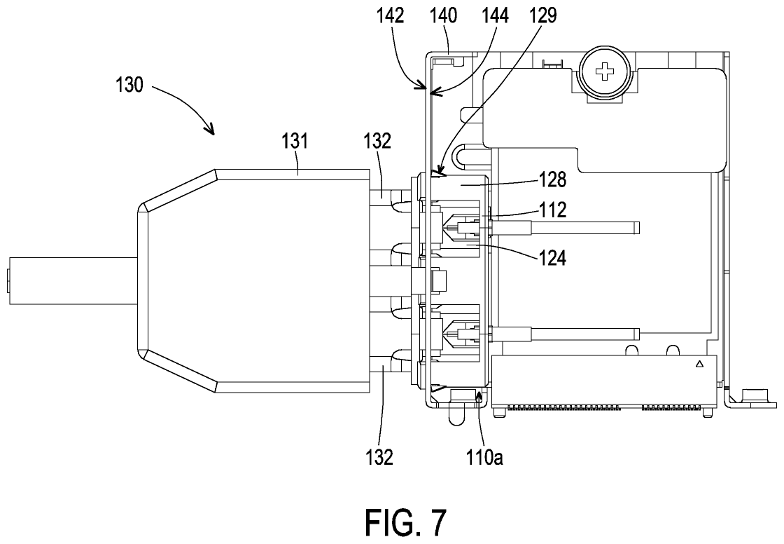

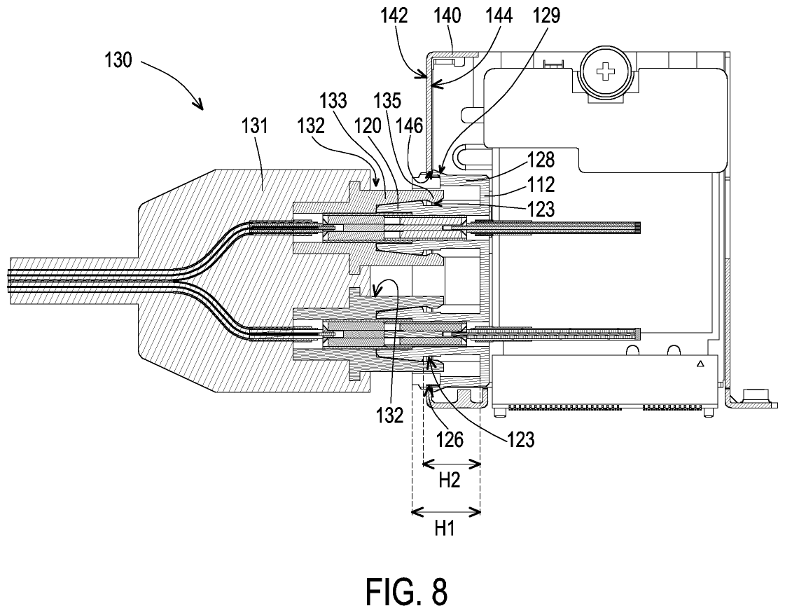

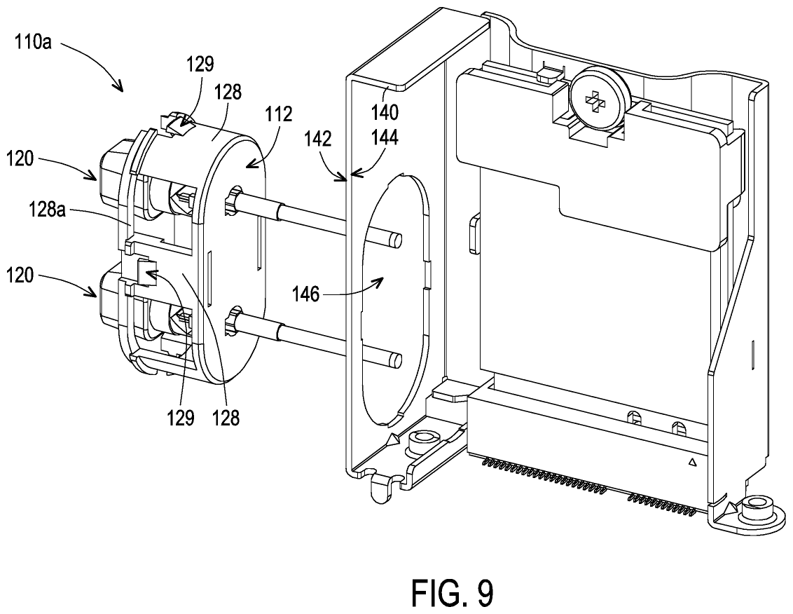

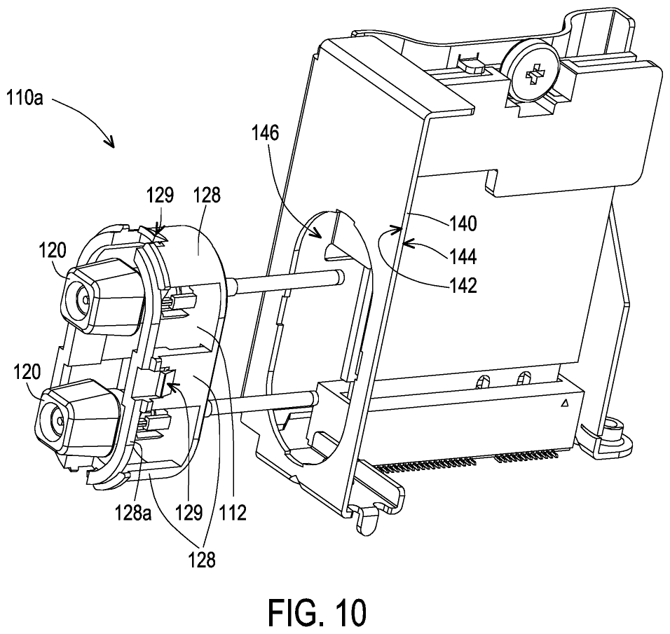

FIG. 6 and FIG. 7 are schematic diagrams of an assembly process of a quick-release module for antenna connectors according to another embodiment of this disclosure. FIG. 8 is a schematic cross-sectional view of FIG. 7. FIG. 9 and FIG. 10 are schematic exploded views from different perspectives of a first double connector assembly and a bracket of the quick-release module for antenna connectors in FIG. 6.

Please refer to FIG. 6 to FIG. 10. The main difference between this embodiment and the previous embodiment is that, in this embodiment, a first double connector assembly 110a also includes an exterior wall 128 extending from the bottom plate 112 and located outside the two first connectors 120, the third engaging portion 126 located on the exterior wall 128 and away from the bottom plate 112, and an inclined surface 129 protruding from an outer wall of the exterior wall 128 and inclined toward the direction of the bottom plate 112. The position where the inclined surface 129 is located may be slightly deformed outward or inward relative to the exterior wall 128.

In this embodiment, there are multiple exterior walls 128 and multiple inclined surfaces 129. The exterior walls 128 are connected through connecting portions 128a to increase structural strength. In other embodiments, there may be only one exterior wall 128, and the connecting portion 128a does not need to be provided.

In this embodiment, the bracket 140 includes one hole 146. When the first double connector assembly 110a is assembled on the bracket 140, the bottom plate 112 and a part of the exterior wall 128 pass through the hole 146, and the inclined surface 129 is pushed by a wall surface of the hole 146, so that the exterior wall 128 is deformed toward the direction of the first connector 120 until the wall surface engages with the third engaging portion 126.

As shown in FIG. 8, when the first double connector assembly 110a is assembled on the bracket 140, the bottom plate 112 and a part of the exterior wall 128 protrude from the inner surface 144, and the inclined outer wall 121 of the first connector 120 protrudes from the outer surface 142. Such design can shorten the height of the first double connector assembly 110a protruding from the outer surface 142 of the bracket 140, thereby reducing the probability of damage to the first double connector assembly 110a from being hit by a foreign object.

A height H1 of the exterior wall 128 protruding from the bottom plate 112 is greater than a distance H2 between the first engaging portion 123 and the bottom plate 112. When the second double connector assembly 130 is plugged into the first double connector assembly 110a, the second engaging portion 135 is located inside the exterior wall 128. Therefore, the exterior wall 128 can also well protect the docked first connector 120 and second connector 132.

To sum up, in the quick-release module for the antenna connector of this disclosure, when the second double connector assembly is plugged into the first double connector assembly, the second engaging portion moves along the corresponding inclined outer wall and engages with the first engaging portion. Therefore, the quick-release module for the antenna connector of this disclosure directly engages during the insertion process to implement quick assembly without the need for tools. In addition, the second double connector assembly of the quick-release module for the antenna connector of this disclosure is detachably plugged into the first double connector assembly. Such design can not only disassemble and assemble the two double connectors at once to increase the disassembling and assembling efficiency, but can also enable the first double connector assembly to have a more robust structural strength since the bottom plate of the first double connector assembly is integrated with the two first connectors, reducing the probability of the first double connector assembly being tilted due to gravity when the second double connector assembly is plugged into the first double connector assembly.

What is claimed is:

1. A quick-release module for antenna connectors, comprising:
a first double connector assembly, comprising a bottom plate and two first connectors extending from the bottom plate, wherein the bottom plate is integrated with the two first connectors, and each of the first connectors comprises an inclined outer wall inclined away from the bottom plate and a first engaging portion located between the inclined outer wall and the bottom plate;
a second double connector assembly, detachably plugged into the first double connector assembly and comprising a housing base and two second connectors fixed on the housing base, wherein each of the second connectors comprises a first elastic arm and a second engaging portion located at an end of the first elastic arm, wherein
when the second double connector assembly is plugged into the first double connector assembly, the second engaging portion moves along the corresponding inclined outer wall and engages with the first engaging portion.

2. The quick-release module for antenna connectors according to claim 1, wherein the bottom plate comprises a first surface and a second surface opposite to each other, the two first connectors protrude from the first surface, the first double connector assembly also comprises two sleeves protruding from the second surface, two sets of inclined blocks located outside the two sleeves and inclined away from the bottom plate, and two third engaging portions located between the two sets of inclined blocks and the bottom plate, and each set of the two sets of inclined blocks surround the corresponding sleeve and forms a gap with the sleeve.

3. The quick-release module for antenna connectors according to claim 2, further comprising a bracket comprising two holes, wherein the first double connector assembly is detachably assembled on the bracket, and when the first double connector assembly is assembled on the bracket, the two sleeves pass through the two holes respectively, each set of the two sets of inclined blocks is pushed by a wall surface of the corresponding hole and is deformed toward a direction of the corresponding sleeve until the set of inclined blocks passes through the hole, so that the wall surface of the hole engages with the third engaging portion.

4. The quick-release module for antenna connectors according to claim 3, wherein the bracket comprises an outer surface and an inner surface opposite to each other, and when the first double connector assembly is assembled on the bracket, the bottom plate and the two first connectors protrude from the outer surface, and the two sleeves and the two sets of inclined blocks protrude from the inner surface.

5. The quick-release module for antenna connectors according to claim 1, wherein the first double connector assembly also comprises an exterior wall extending from the bottom plate and located outside the two first connectors, a third engaging portion located on the exterior wall and away from the bottom plate, and an inclined surface protruding from the exterior wall and inclined toward a direction of the bottom plate.

6. The quick-release module for antenna connectors according to claim 5, further comprising a bracket comprising a hole, wherein the first double connector assembly is detachably assembled on the bracket, and when the first double connector assembly is assembled on the bracket, the bottom plate and a part of the exterior wall pass through the hole, and the inclined surface is pushed by a wall surface of the hole, so that the exterior wall is deformed toward a direction of the first connector until the wall surface engages with the third engaging portion.

7. The quick-release module for antenna connectors according to claim 6, wherein the bracket comprises an outer surface and an inner surface opposite to each other, and when the first double connector assembly is assembled on the bracket, the bottom plate and a part of the exterior wall protrude from the inner surface, and the inclined outer wall protrudes from the outer surface.

8. The quick-release module for antenna connectors according to claim 5, wherein a height of the exterior wall protruding from the bottom plate is greater than a distance between the first engaging portion and the bottom plate, and when the second double connector assembly is plugged into the first double connector assembly, the second engaging portion is located inside the exterior wall.

9. The quick-release module for antenna connectors according to claim 1, wherein a thickness of the first elastic arm gradually decreases along with a height protruding from the housing base to present an inclined inner wall.

10. The quick-release module for antenna connectors according to claim 1, wherein the second engaging portion comprises an arc surface, the inclined outer wall has a sharp corner near the first engaging portion, and when the second double connector assembly is unplugged from the first double connector assembly, the arc surface of the second engaging portion deforms the first elastic arm along the sharp corner and disengages from the first engaging portion.
